(19) United States
(12) Patent Application Publication
(10) Pub. No.: US 2022/0261493 A1
(43) Pub. Date: Aug. 18, 2022

(54) Method and System for Protecting Consumer Privacy and Exercising Statutory Rights

(71) Applicant: Karina KLEVER, Thousand Oaks, CA (US)

(72) Inventor: Karina KLEVER, Thousand Oaks, CA (US)

(73) Assignee: Privacy Monitor, Inc., Thousand Oaks, CA (US)

(21) Appl. No.: 17/175,376

(22) Filed: Feb. 12, 2021

(51) Int. Cl. G06F 21/62; G06Q 50/18

(52) U.S. Cl. CPC G06F 21/6245; G06Q 50/18; G06F 21/6272

(57) ABSTRACT

A semi-automated system operative to identify statutory privacy rights of a user vis a vis at least one data repository and to assist the user to exercise a statutory right. Some functions, which may be fully automated, periodically request, on behalf of a user, that a data repository delete any information it may have collected about the user.

This is an original U.S. patent application.

### FIELD

The invention relates to consumer privacy. More specifically, the invention relates to systems and methods which allow consumers to manage, control and monitor requests sent to companies that they frequent, to ensure compliance with applicable statues.

### BACKGROUND

Electronic computation, data collection, digital recording and wide-area communications were once limited to large corporate purposes, but advances in technology and economics have made it possible and common to collect and distribute vast quantities of information about utterly mundane things. Today, even common mundane transactions such as buying milk can result in storing data that is used to create algorithmic projections for when to target a coupon for when you may buy milk again based on purchase history. When purchasing milk, it would seem (to the consumer) that a singular purchase would be inconsequential, however when a thousand inconsequential actions are brought together in a database, the information can easily be used for identity theft and fraud. The methods and security protocols used to protect consumer information varies widely in-between companies, resulting in breaches and data leaks due to inconsistent storage, access, and cybersecurity controls.

The greatly expanded collection and storage of electronic information has been a boon to commercial enterprises, which strive to learn more about their customers in order to serve them better. But the information has also attracted malefactors who would use it to facilitate financial crimes. Experience has shown that the collectors of consumer information are not always competent in protecting information from theft. Additionally, companies frequently sell or share consumer information, causing a multiplication in locations where consumer information resides, which increases the risk for breaches or leaks. According to Identity Force, one-third of all Americans have experienced identity theft which is more than twice the global average, with children being a victim more than 51% or the time, and a victim every 2 seconds.

Some states have enacted laws designed to provide increased protection for consumer data and/or to provide a framework for consumers to control the collection and use of data about themselves, but the legislative landscape is currently a patchwork of varying duties, rights, obligations and contact procedures. Protection is available to some consumers, but taking advantage of it is still extremely challenging. For example, consumers may find it difficult to determine which company owes them a specific data privacy action. Consumers also have trouble managing the specific timing of processes for follow-ups and keeping them centrally organized. Beyond companies with which consumers have a direct commercial relationship, consumers may not know how to find other companies—“data brokers”—which also have the consumers' information, and which represent a significant potential for data loss and identity theft.

A service that reduces the burden on the consumer of exercising her rights may provide dual benefits, by allowing the consumer to use the protection she has already paid for (legislative compliance costs are factored into consumer retail prices) and holding companies to account for substandard information-security practices.

### BRIEF DESCRIPTION OF DRAWINGS

FIG. 1 is a flow chart providing an overview of characteristics of the methods involved in an embodiment.

FIG. 2 shows several general categories of “people, places and things” that are involved in an embodiment.

FIG. 3 shows an example sequence of operations that may be undertaken by an embodiment.

FIG. 4 shows a simpler sequence of operations that may be undertaken by an embodiment.

FIG. 5 shows a more-complex sequence of operations that may be undertaken by an embodiment.

FIG. 6 outlines a process for reducing the amount of personally-identifiable information about consumers that is held by business-to-business data repositories (“data brokers”).

FIG. 7 shows a sequence of operations that may be undertaken by an embodiment in response to a data breach.

FIG. 8 shows a follow-on sequence of operations of an embodiment.

FIG. 9 shows another possible sequence of operations according to an embodiment.

### DETAILED DESCRIPTION

An embodiment of the invention may comprise data collection functions, automatic monitoring for breach notification, automatic or user-directed issuance of Privacy Enactment Requests (“PERs”), and deadline tracking (with PER reissuance), all combined into a user-accessible website having software agents to collect, format and display the status of a user's information and PERs. A Privacy Enactment Request is a communication to a data repository, sent by an embodiment on behalf of a consumer, that requests, instructs or demands that the data repository take a statutorily-required action with respect to personally-identifiable information about the consumer that is in the possession, custody or control of the data repository. Some statutory frameworks call this a Data Subject Access Request (“DSAR”) such as in the GDPR law in Europe. We will use PER for all similar requests and in the content of this document. The action may be to delete the information, to deliver a copy of the information to the embodiment for presentation to the consumer, to correct errors in the information, or to alter the permissions given to the data repository for its use of the data. PERs can also be used to support the performance of broader methods that are helpful when attempting to mitigate or remediate the adverse effects of a data repository's loss of control over the consumer's information (i.e., when the data repository suffers a breach).

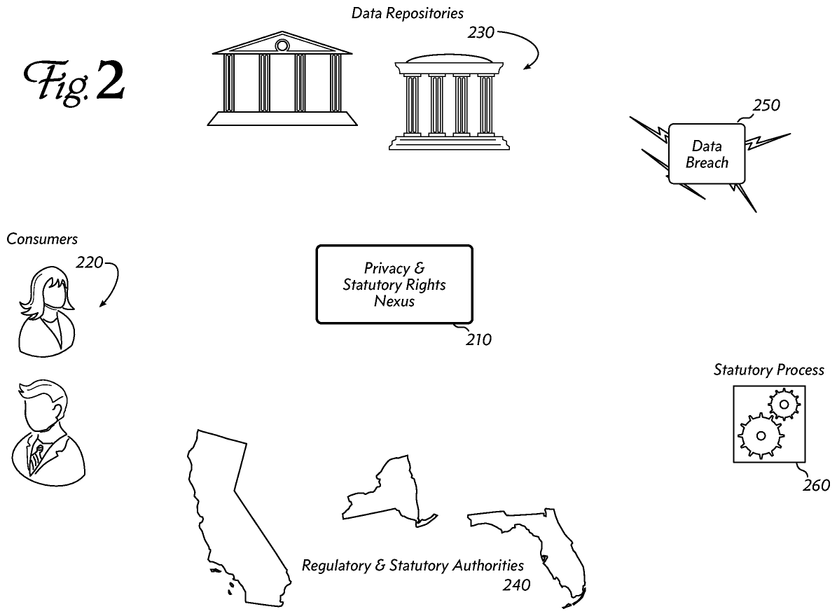

FIG. 2 shows several general categories of things that are involved in operations according to an embodiment of the invention. The embodiment occupies a central position, identified as Privacy & Statutory Rights Nexus 210, and it interacts with a number of entities and events. First, the embodiment principally serves consumers 220, who are individuals who live or work where the embodiment operates. A second important group of participants are data repositories 230, which are often commercial entities with which consumers 220 interact. However, for purposes of an embodiment, data repositories are defined as entities which collect, store or use information about consumers, when the information is such that individual consumers can be identified by the information, or by the information in conjunction with other information. Note that some data repositories have no direct relationship with any consumer; instead, they are business-to-business concerns that may purchase, correlate, augment or sell information about consumers, with neither knowledge nor consent therefrom.

An embodiment also interacts with (and is affected by) regulatory and statutory authorities 240, represented in this drawing by outlines of several U.S. states. This category includes states, cities, municipalities, and the U.S. federal government, to the extent that these entities set and enforce rules and requirements for data repositories 230 and consumers 220. An embodiment may also interact with (or be affected by) international regulatory and statutory authorities.

An embodiment is also concerned with two types of events: data breaches 250, where information in a data repository is lost or misused in a way that fits a rule promulgated by a regulatory or statutory authority 240; and statutory processes 260, which set forth conditions and procedures by which a consumer 220 can compel a data repository 230 to provide information about the repository's data concerning the consumer, to delete (or otherwise restrict) the data repository's use of that data, or can affect the data repository's use of the consumer's information in another way.

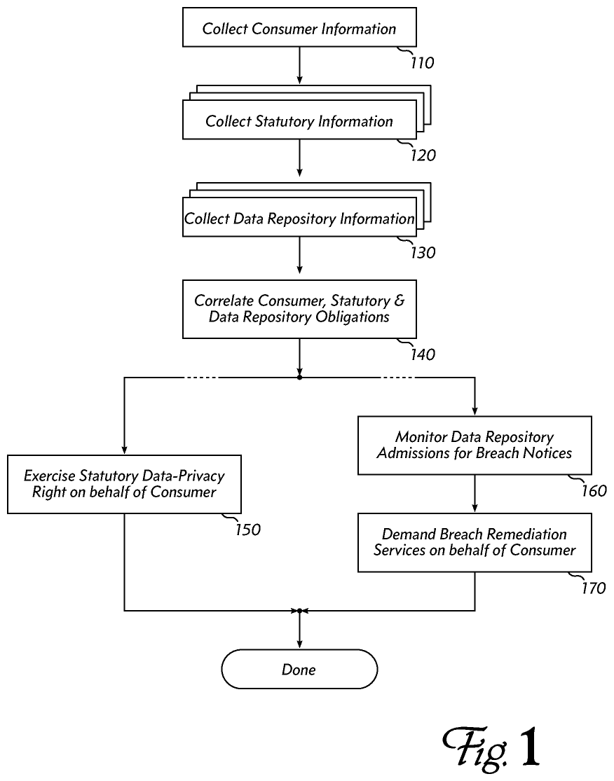

Within this environment, an embodiment operates broadly as set forth in FIG. 1. First, information about a consumer is collected (110). Information about statutes or regulations applicable in a geographic area and/or to particular people and entities is also collected (120). (The figure indicates that this sort of information is voluminous: there may be many different laws or regulations that apply to different people, places or things.)

An embodiment also collects information about (numerous) data repositories (130). For example, entities that collect, use or store information about consumers may be required to register with a statutory authority in order to legally operate in a particular jurisdiction. An embodiment may obtain some data-repository information from such registrations.

When “information” (or, often, “identifying information”) is mentioned in connection with an embodiment, it refers to at least the sorts of information used later in connection with the operation of the embodiment. For example, consumer information (e.g. 110) often includes the consumer's full name and residence address. It may include her phone number, an email address, government-issued identifying numbers, or the like. A consumer's name may be required when an embodiment wishes to identify the consumer to a data repository. A consumer's residence may be required to determine whether the consumer is entitled to exercise a statutory provision that is intended to benefit consumers in a particular city, state or country.

Similar (but generally not identical) information about data repositories is collected. For example, a data repository's jurisdiction of organization or the physical locations where it operates may be needed to determine whether a particular statute applies to the data repository. Other information (such as an electronic-mail address, a paper-mail address or a telephone number) may be essential for an embodiment to send messages to a data repository, or to receive replies therefrom. The choice of which items of information to collect for each category of participant in an embodiment is within the capabilities of an implementer of ordinary skill. Further, standard database operations permit the addition of information to augment an existing record, if the new information was not originally collected but has become necessary for some reason.

After an embodiment collects at least consumer, statutory and data-repository information (collection which may proceed continuously during the operation of the embodiment), a correlation is made between the consumer, statutory and data-repository obligations (140). A result of the correlation is to identify rights and responsibilities of consumers and data repositories based on the effective reach or enforceability of the statutes. More specifically, the correlation identifies information triplets, each triplet containing one consumer, one data repository, and one statutory or regulatory right or responsibility that the consumer is privileged to assert or exercise with respect to the data repository. If the correlation produces a triplet, it means that that the embodiment may issue a Privacy Enactment Request to the data repository on behalf of the consumer, and the data repository is obliged to respond to the PER (or be in violation of the statute).

Based upon the correlation, an embodiment may undertake either of two general classes of activities. First, the embodiment may exercise a statutory data-privacy right of the consumer vis-à-vis one or more of the data repositories (150). In exercising such a right, the embodiment stands in for the consumer herself, to a degree and by a procedure often set forth in the relevant statute.

Another important activity an embodiment undertakes on behalf of a consumer is to monitor data-repository admissions of data breaches (160), in order to detect data breaches that may affect a consumer whose information has been collected. When a breach may affect such a consumer, the embodiment may issue a remediation demand on the breached data repository (170). Again, this demand is made on behalf of the affected consumer, for whom the embodiment stands in.

### SPECIFIC EXAMPLES

The foregoing overview description of an embodiment (paragraphs [0016] through [0026] ) is unavoidably general, as operations depend on many specific details that are mostly set forth in statutes governing relations among the participants with respect to the personally-identifiable information of consumers held or used by data repositories. What follows is a detailed description of several example statutory schemes and the rights, obligations and interactions managed by an embodiment of the invention operating thereunder.

The California Consumer Privacy Act of 2018 (California Civil Code Sections 1798.100 et seq., “CCPA”) is designed to provide certain privacy rights to consumers, including:
The right to know about the personal information a business collects about them and how it is used and shared;
The right to delete personal information collected from them (with some exceptions);
The right to opt-out of the sale of their personal information; and
The right to non-discrimination for exercising their CCPA rights from website of California Secretary of State.

The CCPA has a number of limitations affecting its applicability (e.g., only California residents are entitled to enforce its provisions), but a consumer who is able to enforce a provision may compel a data repository to disclose what personal information about the consumer was collected, used, shared or sold, and why.

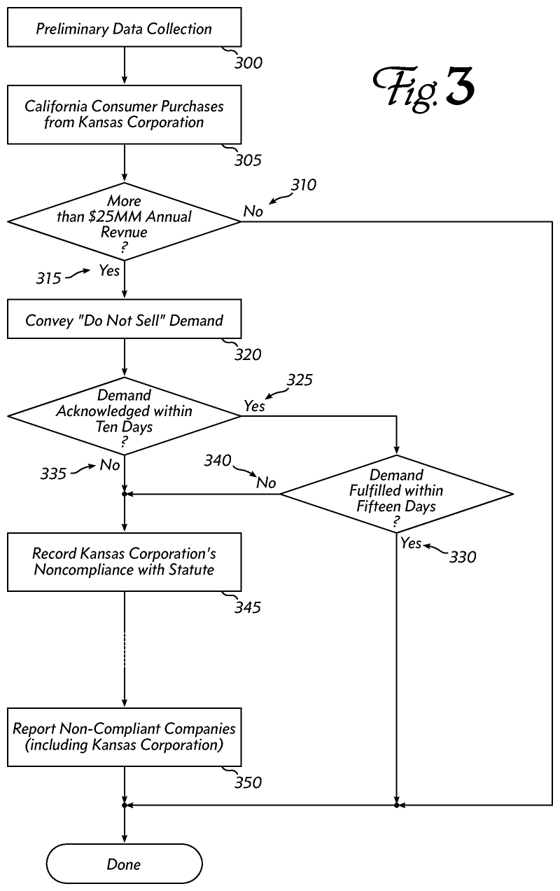

Turning to FIG. 3, we describe a possible sequence of operations according to an embodiment of the invention. We assume that preliminary data collection and correlation (e.g. FIG. 1, 110-140) has already been completed (300). A California-resident consumer makes a purchase from a Kansas corporation (305) in the past. This consumer wishes to exercise her CCPA rights to prohibit the corporation from sharing or selling information about this purchase (and any other information) the Kansas corporation might have about her. To determine whether the Kansas corporation is subject to a CCPA request, the embodiment checks whether the corporation has annual revenue in excess of $25,000,000. If not (310), then the corporation is not subject to the CCPA, so no privacy request should be issued.

If the corporation's revenue is high enough (315), then the embodiment conveys a “Do Not Sell” demand to the corporation (320). This demand starts a deadline-monitor process within the embodiment to detect whether the corporation responds timely. If the Kansas corporation acknowledges the demand within 10 days (a time period set by statute), then the first part of this privacy enactment has completed successfully (325). “Do Not Sell” demands must be fulfilled within 15 days (a time period set by statute). If the Kansas corporation returns confirmation to the California Resident Requestor within 15 days (330), then this entire privacy enactment request has completed successfully.

If the corporation fails to acknowledge the demand within 10 days (335), or it fails to fulfill the demand within 15 days (340), then its statutory noncompliance is recorded by the embodiment (345). Later, perhaps on a monthly schedule, the embodiment makes a report of all compliance failures, including the failure of the Kansas corporation, to the California Secretary of State (or other suitable individual or entity whose responsibilities include ensuring compliance with the CCPA) (350). As described and depicted with reference to FIG. 3, this is a specific example of exercising a statutory data-privacy right on behalf of a consumer (FIG. 1, 150).

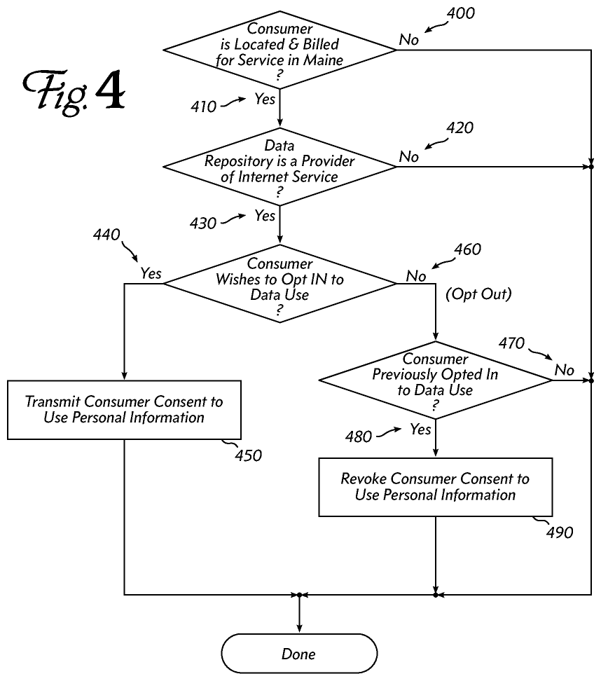

FIG. 4 shows a simpler example sequence of operations that may take place pursuant to the Maine Broadband Internet Access Service Customer Privacy law, Maine Revised Statutes 35-A § 9301. An embodiment of the invention may assist a consumer in exercising her opt-in or opt-out rights under § 9301.3. Preparatory data-collection operations are omitted in this flow chart; they are assumed to have been completed already.

First, the embodiment determines whether the consumer is located and billed for Internet service in Maine. This is a requirement for applicability of the statute. If the consumer is not located in Maine and is not billed for service there (400), then the method terminates—there is nothing to be done.

If the consumer is located in Maine and billed for service there (410), then the data repository is checked. If it is not a provider of Internet service (420), then the method terminates—again, there is nothing to be done. But if the data repository is an Internet service provider (430), then the consumer is queried whether she wishes to allow or prohibit the data repository from using her personal information. If she wishes to opt IN to data use (440), this embodiment transmits the consumer's “express, affirmative consent” to the service provider (450), on behalf of the consumer.

If the consumer instead wishes to opt OUT of allowing the data repository (the Internet service provider) to use her personal information (460), then the embodiment checks whether this consumer previously opted into such use. This is because, under the Maine statute, the default position is to opt out. If the consumer had not previously opted in (470) then no additional action is necessary. However, if the consumer had previously opted in (480), then the embodiment transmits a revocation of the consumer's prior consent to the data repository (490).

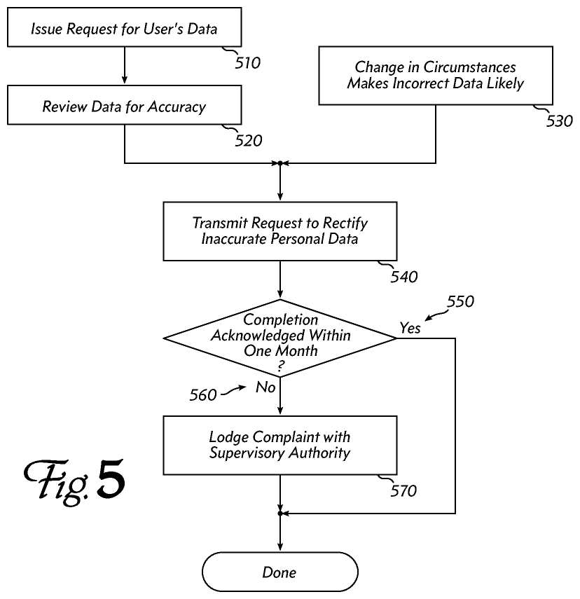

FIG. 5 shows another example sequence of operations that an embodiment may perform for a user. In this example, the embodiment functions to serve a consumer interacting with a data repository according to the General Data Protection Regulation (“GDPR”), a statute affecting data protection and privacy that was enacted by the European Union (“EU”). The specific consumer right being exercised is Article 16, the “Right to rectification:”
The data subject shall have the right to obtain from the controller without undue delay the rectification of inaccurate personal data concerning him or her. Taking into account the purposes of the processing, the data subject shall have the right to have incomplete personal data completed, including by means of providing a supplementary statement.

The user may become aware of an error in personal data about her by making a request for the data (510) and then reviewing the data for accuracy (520). That request may be issued through a prior sequence of operations of an embodiment. Alternatively, the user may have a change in circumstances (e.g. marriage) that makes it likely that a data repository holds incorrect information (530).

In any case, the embodiment transmits a request to rectify inaccurate personal data (540) to the data repository, providing information to identify the user (“data subject”), the corrected data and a request for follow-up (Article 19). A response is expected within one month (Article 12.3). If the response is received (550), then the rectification has succeeded. If not (560), then the embodiment may lodge a complaint with the relevant supervisory authority (570).

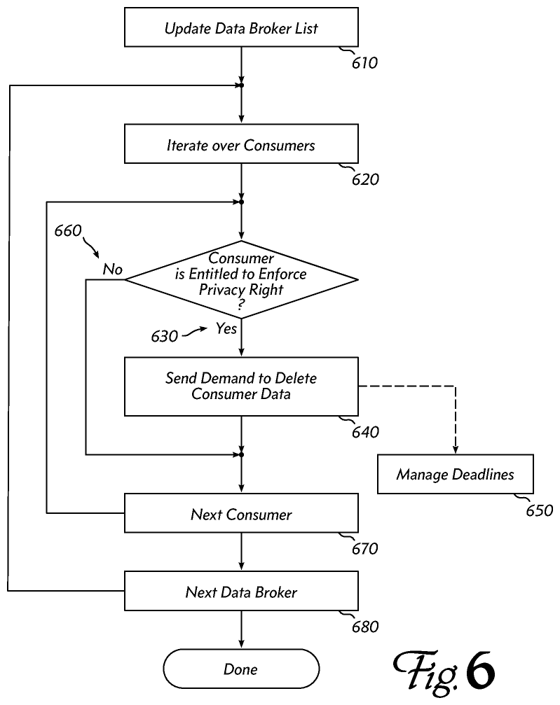

FIG. 6 outlines a final example of operations by an embodiment to exercise a statutory data-privacy right on behalf of a consumer. This sequence illustrates one way of dealing with data repositories which are companies and entities that may have a consumer's personal information, but which have no direct relationship with the consumer. These data repositories may buy, sell, analyze personal information, or profile a consumer's online activities but some only receive the personal information from (or send it to) other companies. Other data brokers may passively collect information about consumers' usage patterns surreptitiously, for example by means of third-party cookies assigned when a consumer interacts with a retailer's website. Such collection may technically be authorized by the consumer, at least enough to satisfy a statutory requirement for such authorization, but the collection is not in the consumer's interest and many consumers would refuse if it was possible to do so without impairing the website functionality. Data repositories with no direct commercial relationship to the consumer, whose activities are not of direct benefit to the consumer, are commonly referred to as “data brokers.”

An embodiment may perform this sequence of operations periodically, such as monthly or semiannually. First, an up-to-date data broker list is prepared (610). This may be accomplished by reference to statutorily-required registrations of such companies, or by other research techniques.

Next, for each data broker in the list, the embodiment iterates over the consumers it serves (620). For each consumer, we determine whether the consumer is entitled to enforce a privacy right against the current data broker. This determination may take into account the location and size of the data broker, the type of information it collects, the residence of the consumer, and statutes, rules or regulations that may affect the relationship between the data broker and the consumer.

If the consumer is entitled to enforce a privacy right against the data broker (630), the embodiment transmits a demand to the data broker on behalf of the consumer, instructing the data broker to delete any information it may have about the consumer (640). This demand typically initiates a multi-step process where the data broker is obliged to respond within a certain time frame, and the embodiment may be required to send additional data to assist the data broker in complying. The embodiment initiates and manages all such deadlines (650), and may detect and/or report statutory noncompliance on the data broker's part.

If the current consumer is not entitled to enforce a privacy right against the data broker (660), then the embodiment proceeds to the next consumer (670). Once the iteration over consumers is complete, the embodiment proceeds to the next data broker (680), and repeats the iteration over consumers (620).

By repeating this process periodically, an embodiment may help reduce the amount of personal information about consumers that is held by—and is therefore at risk of loss by—the data brokers.

It should be apparent from the foregoing examples that an embodiment of the invention may be useful to consumers residing anywhere in the world, that an embodiment can interact with data repositories anywhere in the world, and that an embodiment's operations may occur under a statutory framework promulgated by any local, state, national or foreign authority. Furthermore, an embodiment's actions may be performed by a single computer operating anywhere in the world, or a complete sequence of actions may be performed by cooperating computers that each perform part of the sequence, and communicate with other computers operating at other locations around the world to accomplish the full task. Communication may be carried over a distributed data network such as the Internet.

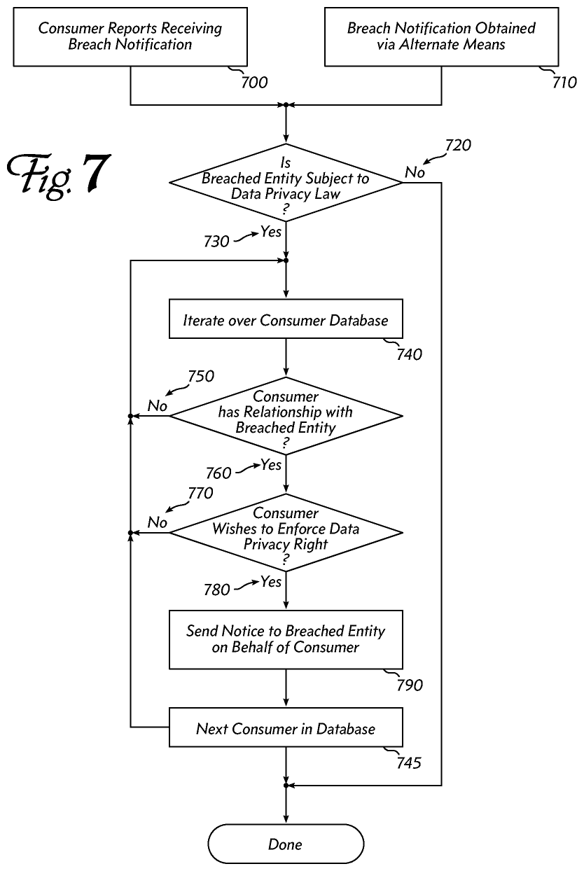

Turning next to FIG. 7, we present a flow chart outlining a possible sequence of operations by an embodiment according to a second general principle of the invention. As in prior examples, collection of various predicate data is assumed to have been accomplished. This flow chart outlines a data-breach response.

The embodiment may become aware of a data breach if a consumer reports that she received a breach notification (700) or by obtaining the notification by alternate means (710). For example, some data repositories are required to report breaches in a public notification; these notifications may be automatically monitored by the embodiment.

If the data repository that suffered a breach (the “breached entity”) is not subject to a data-privacy law, statute, regulation or rule (720), the embodiment may take no further action. (Alternatively, the embodiment may assist the consumer in remediating the breach through other means not relevant to the scope of the present disclosure.)

If the breached entity is subject to a data privacy law (730), then the embodiment iterates over its consumer database (740). For each consumer, if the consumer does not have a recorded relationship with the breached entity (750), the next consumer is examined. If the consumer does have a relationship with the breached entity (760), then she is queried whether she wishes to enforce an available data-privacy right as a result of the breach. If not (770), then the next consumer is examined.

If the consumer does wish to enforce an available data-privacy right (780), then the embodiment sends notice thereof to the breached entity on behalf of the consumer (790). Then the embodiment proceeds to the next consumer in the database (745).

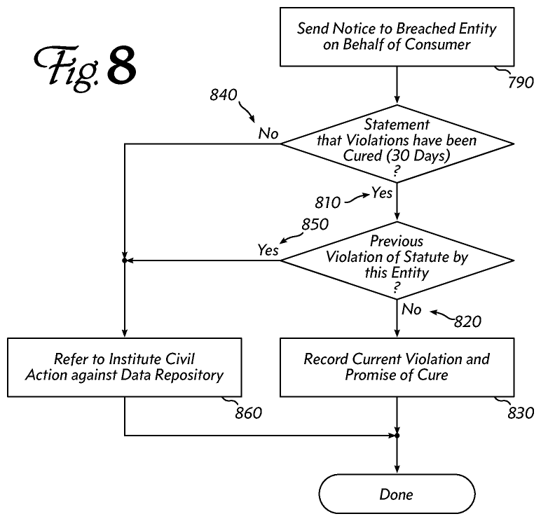

FIG. 8 continues from FIG. 7, 790: after the notice is sent, the embodiment waits thirty days (or another appropriate time period as set forth in the relevant statute) to see whether the breached entity responds with an express written statement that the violations have been cured and that no further violations shall occur. If such a statement is forthcoming (810), then the embodiment checks to see whether the entity had previously violated the statute (and promised that no further violations would occur). If there was no prior violation (820), then the method records the current violation (830) and terminates.

If there is no statement of cure (840) or if the entity had previously violated the statute (850), then the matter is referred to institute a civil action against the data repository on behalf of the consumer (860). This referral may require the involvement of an attorney or counselor who is permitted to represent another person in legal proceedings under the laws of the jurisdiction. An embodiment may transmit the relevant details of the data repository's action or inaction, along with information to identify the affected consumer, to such a representative. This information may have value to the representative, so an embodiment may charge a fee for developing the information and/or providing it to the lawyer.

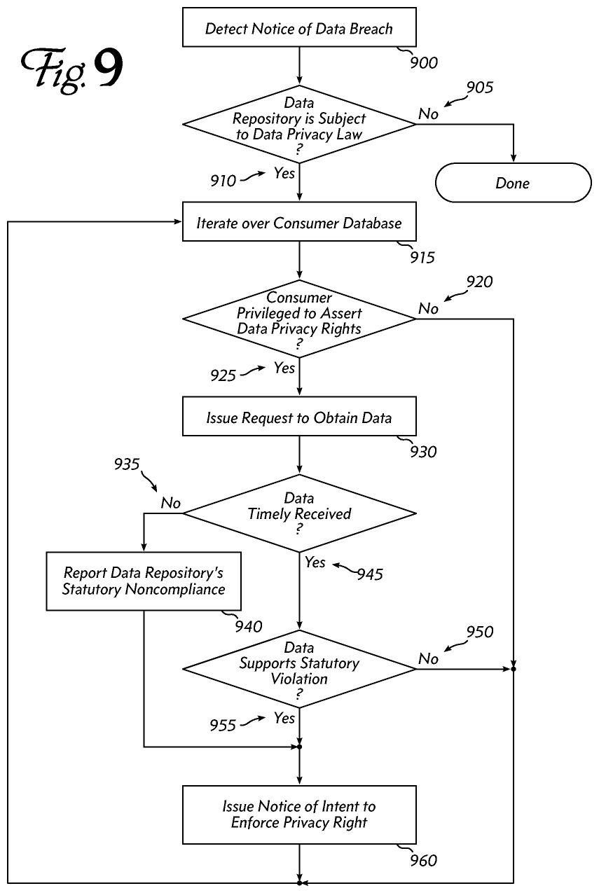

FIG. 9 outlines another data-breach-response method according to an embodiment. In this example sequence, a data breach has occurred at a business-to-business data repository, that is, one that has no direct relationship with consumers. The embodiment begins this process when an automatic monitoring process detects a publicly-disclosed data breach by such a repository (900).

If the data repository is not subject to a data privacy law (e.g., because its annual revenues are lower than a statutory limit or it operates outside the jurisdiction of the law) (905) then the current process terminates. Otherwise (910), the embodiment begins iterating over the consumer database (915). For each consumer:

If the consumer is not privileged to assert a data privacy right under the statute (e.g., because the consumer resides in a different, non-covered jurisdiction) (920), then the embodiment proceeds to the next consumer in the database (915).

If the consumer is privileged to assert a data privacy right (925), then the embodiment issues a request to obtain the consumer's data from the breached entity (930). If the data is not timely received (935) then the entity's noncompliance is reported to the appropriate regulatory authority. If the data is received (945), then it is reviewed to determine whether the loss of that data would support a statutory violation. If not (950), then the embodiment proceeds to the next consumer in the database (915). If the data does support a statutory violation (955) (or if the repository failed to respond to the earlier request to obtain the data), then the embodiment issues a notice of intent to enforce the privacy right (960). This is similar to the notice issued at 790 in FIG. 7, and a procedure similar to FIG. 8 may be performed. In any event, the iteration over the consumer database proceeds to completion.

It is appreciated that some of these steps involve issuing a message and then waiting for a response. The message/response flow between a data repository and an embodiment acting on behalf of one consumer is independent from the message/response flow between the same data repository and the embodiment acting on behalf of another consumer, so these may proceed in parallel. Further, it is possible that one sequence of operations will proceed more quickly than another, and that one consumer may not have a basis to pursue a legal remedy, while another one will. An embodiment tracks various tasks and deadlines for each data repository, each consumer, and each assertion of a privacy right.

An embodiment of the invention may be a machine-readable medium, including without limitation a non-transient machine-readable medium, having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a non-transient machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that the operations to determine which privacy enactments are possible between a consumer (of a group of consumers) and a company or data repository (of a group of companies and data repositories) and then to issue, track and follow up such privacy enactments can also be accomplished by software and hardware that distribute the functions of embodiments of this invention differently than herein described. Such variations and implementations are understood to be captured according to the following claims.

I claim:

1. A method comprising:
collecting identifying information of a plurality of consumers;
collecting identifying information of a plurality of data repositories;
collecting information about a plurality of statutory frameworks for protecting consumer privacy;
correlating the identifying information of the plurality of consumers, the identifying information of the plurality of data repositories, and the information about the plurality of statutory frameworks to produce at least one triplet, wherein each of the at least one triplet represents a triplet statutory right of the plurality of statutory frameworks that a triplet consumer of the plurality of consumers is privileged to assert against a triplet data repository of the plurality of data repositories;
receiving a request from the triplet consumer to assert the triplet statutory right against the triplet data repository;
sending a Privacy Enactment Request (“PER”) to the triplet data repository;
if a response that satisfies the statutory framework is received from the triplet data repository, then notifying the triplet consumer of the response; and
if a response that satisfies the statutory framework is not received from the triplet data repository, then executing a statutory failure process chosen from the group consisting of notifying a statutory authority of a failure of the triplet data repository to adhere to the statutory framework, or commencing a civil action against the triplet data repository on behalf of the triplet consumer for violation of the statutory framework.

2. The method of claim 1 wherein the triplet statutory right is a right to delete information of the triplet consumer from records maintained by the triplet data repository.

3. The method of claim 1 wherein the triplet statutory right is a right to opt into data sharing.

4. The method of claim 1 wherein the triplet statutory right is a right set forth in a California Consumer Privacy Act statute.

5. The method of claim 1 wherein the information about a plurality of statutory frameworks comprises information about a California Consumer Privacy Act and a Maine Broadband Internet Access Service Customer Privacy law.

6. The method of claim 1 wherein the information about a plurality of statutory frameworks comprises information about a statute of a state of a United States and information about a statute of a non-United States jurisdiction.

7. The method of claim 6 wherein the non-United States jurisdiction is a European Union.

8. The method of claim 1 wherein commencing the civil action comprises conveying identifying information of the triplet consumer and the triplet data repository to an attorney who is authorized to present legal claims of a person in a court of a jurisdiction of the triplet statutory right.

9. A website comprising:
a user-registration function to collect information about a consumer;
a data-repository registration function to collect information about a data repository;
a statutory database containing information and relations to describe users, data repositories, rights exercisable by a user, and obligations of a data repository under a statutory scheme;
correlation logic to identify users and data-repositories that may interact under a statutory scheme; and
a user control operative to initiate a Privacy Enactment Request on behalf of the consumer directed to the data repository.

10. The website of claim 9, further comprising
an automatic, periodically-executing process to issue a plurality of Privacy Enactment Requests on behalf of a plurality of consumers to the data repository.

11. The website of claim 10 wherein the plurality of Privacy Enactment Requests is a plurality of demands to delete consumer data.

12. The website of claim 10 wherein the automatic, periodically-executing process occurs once per month.

13. The website of claim 10 wherein the automatic, periodically-executing process occurs semi-annually.

14. A tangible computer-readable medium containing data and instructions to cause a programmable processor to perform operations comprising:
transmitting a first “Do Not Sell” Privacy Enactment Request (“PER”) to a first data repository having personally-identifiable information of a first consumer;
awaiting acknowledgement of the first “Do Not Sell” PER from the first data repository;
if the acknowledgement is not received within a first predetermined period of time, then reporting the first data repository to a statutory authority for failure to comply with a statutory requirement, wherein
the tangible computer-readable medium contains a consumer database listing information about the first consumer, and
the tangible computer-readable medium contains a data repository database listing information about the data repository.

15. The tangible computer-readable medium of claim 14, containing additional data and instructions to cause the programmable processor to perform operations comprising:
transmitting a second “Do Not Sell” PER to the first data repository having personally-identifiable information of a second consumer;
awaiting acknowledgement of the second “Do Not Sell” PER from the first data repository; and
if acknowledgement of the second “Do Not Sell” PER is received from the first data repository is received within the first predetermined period of time, then
reporting a successful PER completion to the second consumer.
